(19) United States
(12) Patent Application Publication
(10) Pub. No.: US 2025/0274020 A1
(43) Pub. Date: Aug. 28, 2025

(54) MOTOR UNIT

(71) Applicant: NIDEC CORPORATION, Kyoto (JP)

(72) Inventors: Yuya SAITO, Kyoto (JP); Koji TSUZUKI, Kyoto (JP)

(21) Appl. No.: 18/693,951

(22) PCT Filed: Sep. 26, 2022
(86) PCT No.: PCT/JP2022/035561

§ 371 Date: Sep. 4, 2024

(30) Foreign Application Priority Data
Sep. 29, 2021 (JP) 2021-159293

(51) Int. Cl. H02K 11/25; H02K 11/33

(52) U.S. Cl. CPC H02K 11/25; H02K 11/33; H02K 2203/09

(57) ABSTRACT

An inverter unit electrically connected to a stator and a bus bar unit electrically connecting the stator and the inverter unit are included. The bus bar unit includes a temperature detection unit that detects a temperature of a bus bar, and a holding portion that holds the bus bar and the temperature detection unit. A connection portion protruding from the holding portion of the temperature detection unit and electrically connected to the inverter unit radially overlaps the bus bar connection portion protruding from the holding portion of the bus bar and electrically connected to the inverter unit.

### CROSS-REFERENCE TO RELATED APPLICATIONS

This is the U.S. national stage of application No. PCT/JP2022/035561, filed on Sep. 26, 2022, and priority under 35 U.S.C. §119(a) and 35 U.S.C. §365(b) is claimed from Japanese Patent Application No. 2021-159293, filed on Sep. 29, 2021.

### FIELD OF THE INVENTION

The present invention relates to a motor unit. The present application claims priority based on Japanese Patent Application No. 2021-159293 filed on Sep. 29, 2021, the content of which is incorporated herein by reference.

### BACKGROUND

In a known motor, a stator includes a bus bar unit having a bus bar electrically connected to a coil, and a temperature detection unit having a temperature detection portion that detects a temperature of the coil. The temperature detection unit is disposed at an axial end portion of the stator, and outputs a signal indicating the temperature of the coil to a control device via a wiring portion.

In the known motor unit, it is necessary to wire the wiring portion of the temperature detection unit to the control device separately from the bus bar unit, which takes time and effort to manufacture. There is a case where a structure for protecting the wiring from vibration and impact at the time of driving the motor is required, and there is a case where the structure becomes complicated.

### SUMMARY

An exemplary motor unit of the present invention includes: a shaft rotatable about a central axis extending vertically; a rotor rotatable about the central axis together with the shaft; a stator radially facing the rotor; an inverter unit electrically connected to the stator; and a bus bar unit electrically connecting the stator and the inverter unit. The bus bar unit includes at least one bus bar, a temperature detection unit that detects a temperature of the bus bar, and a holding portion that holds the bus bar and the temperature detection unit. The bus bar includes a bus bar connection portion protruding from the holding portion. The temperature detection unit includes a temperature detection element fixed to the holding portion, and an energization unit electrically connected to the temperature detection element. The energization unit includes a connection portion protruding from the holding portion and electrically connected to the inverter unit. The connection portion radially overlaps the bus bar connection portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a front view of a motor unit of one embodiment;

FIG. 2 is an exploded perspective view of the motor unit;

FIG. 3 is a perspective view of an inverter unit as viewed from below;

FIG. 4 is a perspective view of a bus bar unit;

FIG. 5 is a schematic arrangement diagram of the bus bar unit;

FIG. 6 is an enlarged cross-sectional view of a bus bar connection portion and a power supply terminal before connection;

FIG. 7 is an enlarged cross-sectional view of the bus bar connection portion and the power supply terminal that are connected;

FIG. 8 is an enlarged cross-sectional view of a cover member of a temperature detection unit;

FIG. 9 is a cross-sectional view of a cover member according to a first modification;

FIG. 10 is a schematic view illustrating a connection portion of a second modification;

FIG. 11 is a perspective view of a cover member according to a third modification;

FIG. 12 is a schematic view of an energization unit according to a fourth modification; and

FIG. 13 is a schematic view of another example of the energization unit of the fourth modification.

### DETAILED DESCRIPTION

Hereinafter, a motor unit according to an embodiment of the present invention will be described with reference to the drawings. Note that the scope of the present invention is not limited to the embodiment described below, but can be changed within the scope of the technical idea of the present invention.

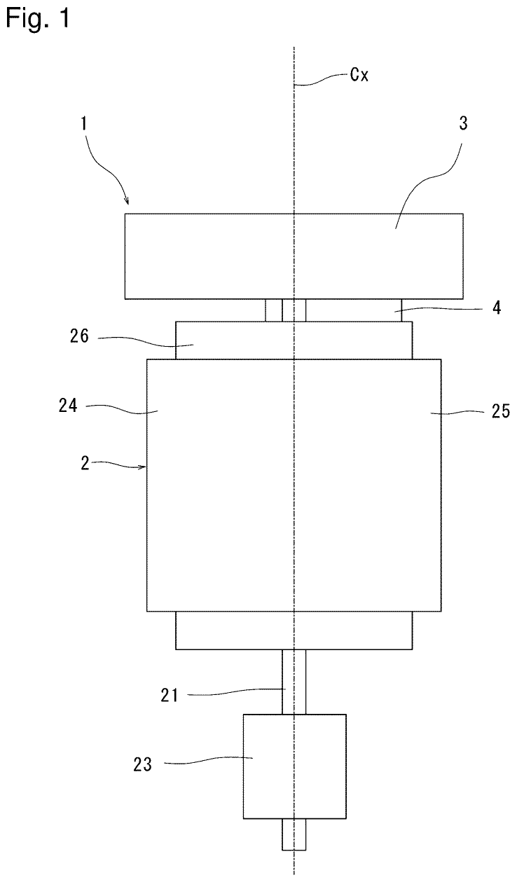

In the present description, a direction parallel to a central axis Cx of a motor unit 1 is an “axial direction” of the motor unit 1. With reference to the state of the motor unit 1 illustrated in FIG. 1, an upper side is axial one direction, and a lower side is an axial other direction. A radial direction orthogonal to the central axis Cx is simply referred to as a “radial direction”, and a circumferential direction about the central axis Cx is simply referred to as a “circumferential direction”. Furthermore, a “parallel direction” described in the present description includes not only a case of a complete parallel but also a substantially parallel direction. Then, “extend along” a predetermined direction or a plane includes not only a case of extending strictly in a predetermined direction but also a case of extending in a direction inclined within a range of less than 45° with respect to the strict direction.

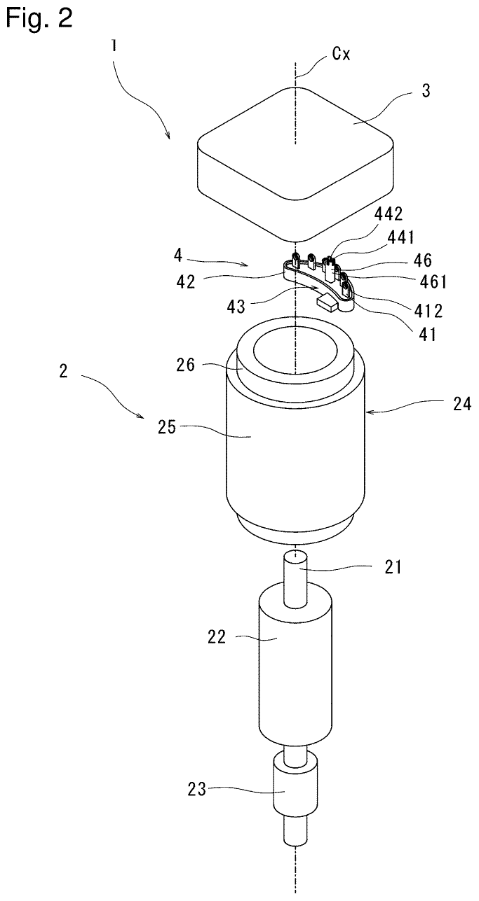

Hereinafter, the motor unit 1 according to one exemplary embodiment of the present invention will be described with reference to the drawings. FIG. 1 is a front view of the motor unit 1 of one embodiment. FIG. 2 is an exploded perspective view of the motor unit 1. Note that the drawings used in the present embodiment are conceptual diagrams. The arrangement and dimensions of each part illustrated in each drawing are not necessarily the same as those of the actual motor unit 1.

As illustrated in FIGS. 1 and 2, the motor unit 1 includes a motor portion 2, an inverter unit 3, and a bus bar unit 4.

As illustrated in FIG. 2, the motor portion 2 includes a shaft 21, a rotor 22, and a stator 24. The shaft 21 has a columnar shape extending vertically. The center of the shaft 21 coincides with the central axis Cx. The shaft 21 is rotatably supported by a housing (not illustrated) via a bearing (not illustrated). That is, the shaft 21 is rotatable about the central axis Cx extending vertically.

As illustrated in FIG. 2, a gear 23 for transmitting torque of the shaft 21 to the outside is disposed at a lower end portion of the shaft 21. The gear 23 meshes with a gear constituting a gear mechanism (not illustrated) included in, for example, a transmission, a speed reducer, and the like, thereby transmitting the torque to the gear mechanism.

The rotor 22 is fixed to an outer peripheral surface of the shaft 21. That is, the rotor 22 is rotatable about the central axis Cx together with the shaft 21.

The stator 24 surrounds the rotor 22 from radially outside. That is, the stator 24 radially faces the rotor 22. The motor portion 2 is an inner rotor motor. The stator 24 is held by a housing (not illustrated) of the motor portion 2.

The stator 24 includes a stator core 25 and a plurality of coils 26. The stator core 25 includes a plurality of magnetic pole teeth (not illustrated) protruding radially inward from an inner peripheral surface of an annular yoke. The coils 26 are formed by winding a conductive wire around magnetic pole teeth. The bus bar unit 4 is connected to the coil 26. A current (e.g., three-phase alternating current) is supplied to the coils 26 via the bus bar unit 4.

The inverter unit 3 is electrically connected to the coil 26 of the stator 24 via the bus bar unit 4. That is, the inverter unit 3 is electrically connected to the stator 24. The inverter unit 3 controls power supplied from a power supply such as a battery not illustrated to the motor portion 2.

As illustrated in FIGS. 1 and 2, the inverter unit 3 is disposed above the motor portion 2. The inverter unit 3 has a waterproof and dustproof structure. The inverter unit 3 receives a temperature signal from a temperature detection unit 43 described later of the bus bar unit 4. The inverter unit 3 acquires the temperature of the coil 26 based on the temperature signal. The inverter unit 3 adjusts the current to be supplied to the coil 26 based on the temperature of the coil 26.

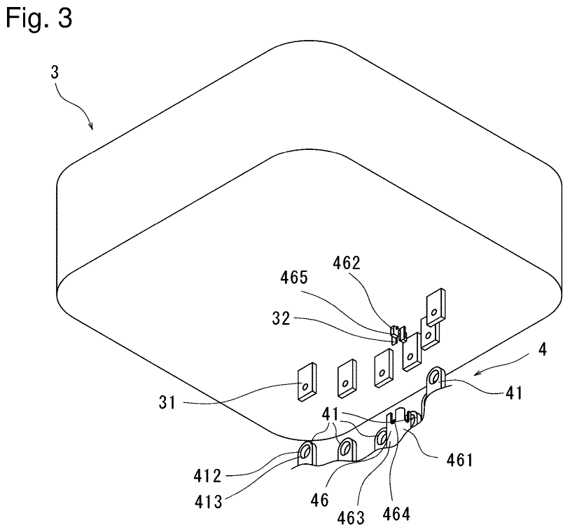

FIG. 3 is a perspective view of the inverter unit 3 as viewed from below. As illustrated in FIGS. 1 to 3, the inverter unit 3 is disposed above the motor portion 2. That is, the inverter unit 3 is disposed on an axial one side of the stator 24.

As illustrated in FIG. 3, the inverter unit 3 has six power supply terminals 31 protruding downward from the lower surface. The power supply terminals 31 are disposed at positions that can be connected to a bus bar connection portion 412 described later of the bus bar unit 4. Each of the power supply terminals 31 is connected to the corresponding bus bar connection portion 412 of the bus bar unit 4.

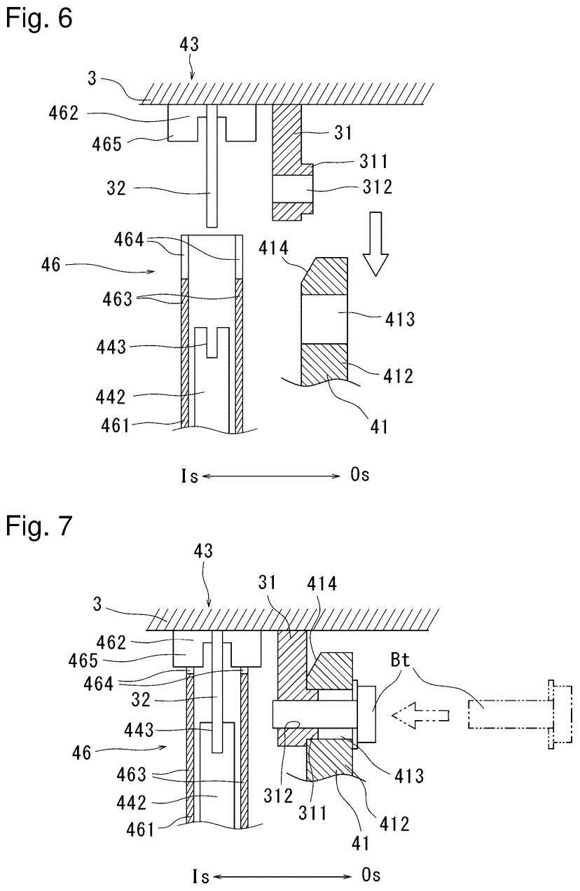

The power supply terminal 31 includes a terminal protrusion portion 311. The terminal protrusion portion 311 has a cylindrical shape and protrudes radially outward from the radially outer surface of the power supply terminal 31. The power supply terminal 31 includes a terminal hole 312. A screw Bt (see FIG. 7 described later) for fixing the bus bar connection portion 412 described later of the bus bar unit 4 is screwed into the terminal hole 312. As illustrated in FIGS. 6, 7, and the like described later, the terminal hole 312 penetrates the power supply terminal 31, but may be a recessed hole having a bottom portion.

The inverter unit 3 includes a pair of inverter connection portions 32 protruding downward from the lower surface. The inverter connection portion 32 is connected with a connection portion 442 of the temperature detection unit 43 described later of the bus bar unit 4. Details of connection and fixing between the inverter unit 3 and the bus bar unit 4 will be described later.

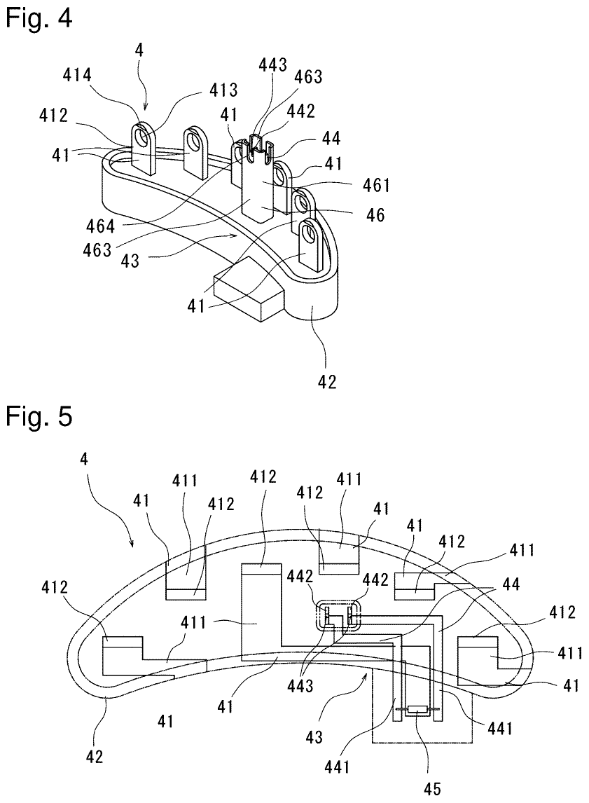

The bus bar unit 4 connects the stator 24 and the inverter unit 3. FIG. 4 is a perspective view of the bus bar unit 4. FIG. 5 is a schematic arrangement diagram of the bus bar unit 4. FIG. 6 is an enlarged cross-sectional view of the bus bar connection portion 412 and the power supply terminal 31 before connection. FIG. 7 is an enlarged cross-sectional view of the bus bar connection portion 412 and the power supply terminal 31 that are connected. Note that FIGS. 6 and 7 illustrate a cover member 46, which will be described later of the temperature detection unit 43, and the inverter connection portion 32. In FIGS. 6 and 7, radial outside and radial inside are indicated by arrows Os and Is, respectively.

As illustrated in FIGS. 4 and 5, the bus bar unit 4 includes six bus bars 41, a holding portion 42, and the temperature detection unit 43. That is, the bus bar unit 4 includes at least one bus bar 41.

The bus bar 41 has conductivity. More specifically, the bus bar 41 is formed by bending a metal plate made of copper, aluminum, or the like. The bus bars 41 are respectively connected to the corresponding coils 26. Then, the bus bar 41 supplies the current from the power supply terminal 31 to the coils 26.

The bus bar 41 includes a bus bar body portion 411 and the bus bar connection portion 412 (see FIG. 5). As illustrated in FIGS. 4, 5, and the like, a part of the bus bar body portion 411 and a part of the bus bar connection portion 412 are disposed inside the holding portion 42.

In the present embodiment, the holding portion 42 is formed of resin. The holding portion 42 is a molded body formed by pouring molten resin into a mold and solidifying the resin. Such configuration makes foreign matters such as water, dirt, and dust hardly enter the inside of the holding portion 42. Therefore, direct contact between the bus bar body portions 411 can be prevented, conduction due to foreign matters can be prevented, and the bus bar body portions 411 can be electrically insulated from each other. The holding portion 42 needs not be a molded body. The holding portion 42 can widely adopt a configuration having an insulating property and in which foreign matters such as water, dirt, and dust hardly enter.

The bus bar body portion 411 expands in a direction intersecting the central axis Cx. The bus bar connection portion 412 has a plate shape and extends axially upward from the bus bar body portion 411. As illustrated in FIGS. 4 and 5, the six bus bar connection portions 412 are arranged side by side in the circumferential direction.

Note that in the present embodiment, the bus bar connection portions 412 are arranged in parallel or substantially parallel, but the present invention is not limited to this. For example, at least some of the bus bar connection portions 412 may have a configuration of expanding in a direction orthogonal to the radial direction.

In the present embodiment, the bus bar body portion 411 and the bus bar connection portion 412 are formed of a single member, but the present invention is not limited to this. For example, the bus bar body portion 411 and the bus bar connection portion 412 may be formed as different members and then fixed by screwing, welding, soldering, or the like. A configuration in which the bus bar body portion 411 and the bus bar connection portion 412 are electrically connected can be widely adopted. The bus bar connection portion 412 protrudes upward from the upper surface of the holding portion 42. That is, the bus bar 41 includes the bus bar connection portion 412 protruding from the holding portion 42. More specifically, the bus bar connection portion 412 protrudes to the axial one side from the holding portion 42.

The bus bar connection portion 412 includes a through hole 413 radially penetrating at the upper portion. The through hole 413 has a shape into which the terminal protrusion portion 311 protruding from the power supply terminal 31 can be inserted. The bus bar connection portion 412 includes a slanting surface 414 with a width in a plate thickness direction decreasing upward, on the central axis Cx side at the upper end.

The bus bar unit 4 is disposed above the stator 24. As described above, the bus bars 41 are respectively electrically connected to the corresponding coils 26. When the bus bar unit 4 is disposed above the stator 24, the bus bar connection portion 412 protrudes upward along the axial direction from the upper surface of the holding portion 42 of the bus bar unit 4.

As illustrated in FIGS. 1, 2, and the like, the inverter unit 3 is disposed on the stator 24 on which the bus bar unit 4 is disposed. At this time, the bus bar connection portions 412 are respectively electrically connected to the corresponding power supply terminals 31. Due to this, the power supply terminals 31 of the inverter unit 3 are respectively electrically connected to the corresponding coils 26 via the bus bar unit 4. That is, the inverter unit 3 can supply a current for rotating the rotor 22 via the power supply terminals 31 and the bus bar unit 4. Details of connection and fixing between the power supply terminal 31 and the bus bar connection portion 412 will be described later.

In the motor unit 1, the bus bar 41 is connected to the coil 26. Heat generated by energization of the coils 26 is transmitted to the bus bar 41. Due to this, the temperature of the bus bar 41 is raised.

The bus bar unit 4 includes the temperature detection unit 43 that detects the temperature of the bus bar 41. The temperature detection unit 43 detects the temperature of the bus bar 41 and transmits the temperature to the inverter unit 3 as a temperature signal. The inverter unit 3 acquires the temperature of the coil 26 based on the temperature signal. The inverter unit 3 adjusts the current to be supplied to the coils 26 based on the acquired temperature of the coil 26.

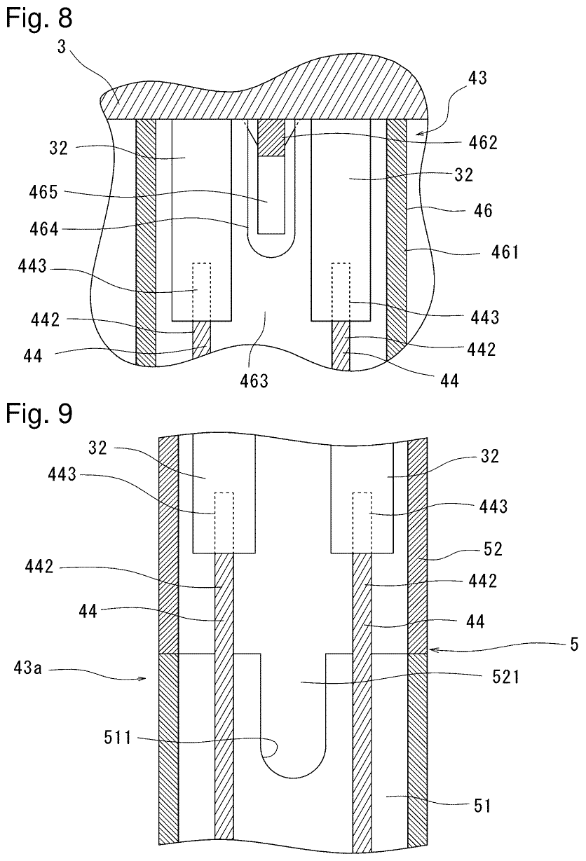

Hereinafter, details of the temperature detection unit 43 will be described with reference to the drawings. FIG. 8 is an enlarged cross-sectional view of the cover member 46 of the temperature detection unit 43. The temperature detection unit 43 includes an energization unit 44, a temperature detection element 45, and the cover member 46. The energization unit 44 has conductivity. In the present embodiment, similarly to the bus bar 41, the energization unit 44 is formed by bending a metal plate made of copper, aluminum, or the like. However, the present invention is not limited to this, and the energization unit 44 may have a configuration in which the tip end of a conductive wire is provided with a detachable terminal. The energization unit 44 can be widely adopted with a configuration having conductivity in which one end can be connected to the temperature detection element 45 and the other end can be connected to the inverter unit 3.

As illustrated in FIG. 5, a pair of the energization units 44 includes a conductive portion 441 and the connection portion 442. The conductive portion 441 is disposed inside the holding portion 42 and is held by the holding portion 42. At this time, contact of foreign matters such as water, dirt, and dust with the conductive portion 441 is prevented. That is, the energization unit 44 is held by the holding portion 42.

The connection portion 442 extends upward from the conductive portion 441 along the axial direction. The connection portion 442 protrudes axially upward from the upper surface of the holding portion 42. That is, the connection portion 442 protrudes 42 to the axial one side from the holding portion.

As illustrated in FIGS. 3 to 7 and the like, the connection portion 442 is disposed closer to the central axis Cx than the bus bar connection portion 412 as viewed from the axial direction. That is, the connection portion 442 is disposed radially inward (FIGS. 6 and 7, arrow Is) relative to the bus bar connection portion 412. Note that the connection portion 442 may be disposed radially outward (FIG. 6, FIG. 7, and arrow Os) relative to the bus bar connection portion 412. That is, the connection portion 442 radially overlaps the bus bar connection portion 412.

The connection portion 442 includes a connection recess portion 443 recessed downward at the upper end portion. When the inverter unit 3 is disposed above the stator 24, the inverter connection portion 32 is inserted into the connection recess portion 443. Due to this, the connection portion 442 is stably electrically connected to the inverter connection portion 32. That is, the energization unit 44 includes the connection portion 442 protruding from the holding portion 42 and electrically connected to the inverter unit 3. Due to this, the wiring work of the temperature detection unit 43 can be easily performed.

The temperature detection element 45 is electrically connected to each conductive portion 441. That is, the energization unit 44 is electrically connected to the temperature detection element 45. Such configuration enables the inverter unit 3 to apply a voltage to the temperature detection element 45 via the energization unit 44.

The temperature detection element 45 is in contact with one of the bus bars 41. More specifically, the temperature detection element 45 comes into contact with a part of the bus bar 41 disposed inside the holding portion 42 of the bus bar body portion 411. At this time, the temperature detection element 45 is fixed to the holding portion 42.

In place of an NTC thermistor, a positive temperature coefficient (PTC) thermistor having a positive temperature coefficient and increasing in resistance value as the temperature rises may be used as the temperature detection element 45. The temperature detection element 45 is disposed inside the holding portion 42. The holding portion 42 holds the bus bar 41 and the temperature detection unit 43.

In the present embodiment, the inverter unit 3 detects the temperature of the bus bar 41 by detecting a change in the resistance value of the temperature detection element 45. Specifically, the inverter unit 3 applies a constant voltage to the temperature detection element 45 via the energization unit 44. Then, the inverter unit 3 acquires, as a temperature signal, a current flowing through the temperature detection element 45 or a voltage between both ends.

Based on the temperature signal, the inverter unit 3 acquires the temperature of the coils 26 to which the bus bar 41 with which the temperature detection element 45 is in contact is connected. The inverter unit 3 adjusts a current value to be supplied to the coils 26 based on the temperature of the coils 26. This keeps the temperature of the coils 26 within a certain range, and suppresses unevenness in rotation of the shaft 21 and the rotor 22 due to temperature change. That is, the shaft 21 and the rotor 22 are stably rotated.

The cover member 46 has an insulation property. The cover member 46 includes a first member 461 and a second member 462. As illustrated in FIG. 7, the first member 461 of the cover member 46 protrudes upward from the upper surface of the holding portion 42. That is, the cover member 46 is formed integrally with the holding portion 42. The first member 461 has a tubular shape, and the connection portion 442 of the energization unit 44 is disposed therein. That is, the cover member 46 covers the outer periphery of the connection portion 442. This can enhance the insulation property between the connection portion 442 and the bus bar connection portion 412. When the connection portion 442 and the bus bar connection portion 412 can be reliably insulated, the cover member 46 may be omitted.

The first member 461 may be in contact with or not in contact with the connection portion 442. In the temperature detection unit 43 according to the present embodiment, the connection portion 442 is in contact with the first member 461 and is supported by the first member 461.

A cross-sectional shape taken along a plane orthogonal to the central axis Cx of the first member 461 is a rectangular shape. Then, the first member 461 has a tubular shape having wall portions 463 radially arranged side by side. The wall portions 463 extend in the circumferential direction. A circumferential intermediate portion (e.g., circumferential central portion) of the upper end of the wall portion 463 includes a recess portion 464 recessed downward. That is, the cover member 46 includes the first member 461 having the recess portion 464.

In the motor unit 1 in the present embodiment, the second member 462 includes a protrusion portion 465 protruding downward along the axial direction from the lower surface of the inverter unit 3. The second member 462 is disposed inside the recess portion 464 of the first member 461. That is, the cover member 46 includes the second member 462 having the protrusion portion 465 accommodated inside the recess portion 464.

That is, the first member 461 is disposed on one of the inverter unit 3 and the holding portion 42, and the second member 462 is disposed on the other of the inverter unit 3 and the holding portion 42. More specifically, at least one of the inverter unit 3 and the holding portion 42 includes at least a part of the cover member 46.

The inverter unit 3 is disposed above the motor portion 2. At this time, the bus bar unit 4 connected to the coil 26 is disposed above the motor portion 2. The bus bar unit 4 is fixed to the stator 24 of the motor portion 2 by a fixing structure not illustrated. Attachment of the inverter unit 3 to the motor portion 2 will be described.

The inverter unit 3 is disposed above the motor portion 2. At this time, the position of the inverter unit 3 is accurately positioned with respect to the bus bar unit 4. Note that the accurate position of the inverter unit 3 with respect to the bus bar unit 4 is a position where the power supply terminal 31 of the inverter unit 3 and the bus bar connection portion 412 of the bus bar unit 4 are in contact with each other when viewed from the axial direction (see FIG. 3 and the like).

In a state where the inverter unit 3 is positioned with respect to the bus bar unit 4, the inverter unit 3 is moved downward (see FIG. 6). At this time, the radially outer surface of the power supply terminal 31 of the inverter unit 3 comes into contact with the radially inner surface of the bus bar connection portion 412. When viewed from the axial direction, the power supply terminal 31 and the bus bar connection portion 412 may partially overlap each other. In such a case, the lower end portion of the power supply terminal 31 comes into contact with the slanting surface 414 of the bus bar connection portion 412. Then, the slanting surface 414 is pushed by the power supply terminal 31, the bus bar connection portion 412 elastically deforms, and the bus bar connection portion 412 comes into contact with the radially outer surface of the power supply terminal 31.

When the inverter unit 3 moves downward, the terminal protrusion portion 311 of the power supply terminal 31 comes into contact with the slanting surface 414. Due to this, the slanting surface 414 is pushed radially outward (FIG. 6, FIG. 7, and arrow Os) by the terminal protrusion portion 311, and the bus bar connection portion 412 elastically deforms. When the inverter unit 3 further moves downward, the terminal protrusion portion 311 is inserted into the through hole 413 of the bus bar connection portion 412. At this time, the bus bar connection portion 412 elastically deformed radially outward returns to its original shape. Due to this, an elastic force toward the power supply terminal 31 acts on the bus bar connection portion 412.

In this state, the screw Bt is inserted into the through hole 413 from the radially outer side (FIG. 7, arrow Os), and the tip end of the screw Bt is screwed into a female screw not illustrated formed on the inner surface of the terminal hole 312. The power supply terminal 31 and the bus bar connection portion 412 are firmly fixed. Due to this, even when vibration or impact acts on the motor portion 2, the inverter unit 3, the bus bar unit 4, and the like, the power supply terminal 31 and the bus bar connection portion 412 are reliably electrically connected.

When the inverter unit 3 and the bus bar unit 4 are connected, the lower end portion of the inverter connection portion 32 is fitted into the connection recess portion 443 at the upper end of the connection portion 442 of the temperature detection unit 43. Due to this, the temperature detection unit 43 is electrically connected to the inverter unit 3.

When the inverter unit 3 is brought close to the bus bar unit 4, the protrusion portion 465 of the second member 462 is accommodated in the recess portion 464 of the first member 461 of the cover member 46 of the temperature detection unit 43. Due to this, the second member 462 of the cover member 46 is positioned with respect to the first member 461.

As a result, the inverter connection portion 32 is accurately positioned above the connection recess portion 443 of the connection portion 442 of the temperature detection unit 43. By inserting the inverter connection portion 32 into the connection recess portion 443 of the connection portion 442 in this manner, the connection portion 442 and the inverter connection portion 32 are reliably electrically connected. The connection portion 442 and the inverter connection portion 32 are less likely to be detached by vibration and impact caused by the operation of the motor portion 2. Therefore, the motor unit 1 can be stably driven.

Thus, a configuration in which the connection portion 442 protrudes from the holding portion 42 of the bus bar unit 4 eliminates the need for a wiring for connecting the temperature detection unit 43 to the inverter unit 3. Therefore, efforts at the time of manufacturing and maintenance of the motor unit 1 can be saved.

That is, by disposing the protrusion portion 465 in the recess portion 464, it is possible to accurately attach the connection portion 442 to the inverter unit 3. The inverter unit 3 itself can be positioned, and the inverter unit 3 can be attached to an accurate position with respect to the stator 24.

The width of the recess portion 464 of the first member 461 is larger than the thickness of the protrusion portion 465 of the second member 462. Therefore, the protrusion portion 465 is easily fitted into the recess portion 464, and the inverter unit 3 is roughly positioned by the protrusion portion 465 being fitted into the recess portion 464. However, the present invention is not limited to this, and may have a shape in which the protrusion portion 465 of the second member 462 is disposed in contact with the inner surface of the recess portion 464 of the first member 461. Such a shape enables more accurate positioning.

The screw Bt is inserted into the through hole 413 of the bus bar connection portion 412 from the radially outside (FIG. 7, arrow Os), and screwed into the terminal hole 312 of the power supply terminal 31 to be fixed. Since the connection portion 442 of the temperature detection unit 43 is disposed radially inward (FIGS. 6 and 7, arrow Is) relative to the bus bar connection portion 412 and the power supply terminal 31, the screw Bt and the connection portion 442 do not interfere with each other at the time of screwing. This facilitates attachment of the inverter unit 3 to the stator 24.

When the inverter unit 3 is attached to the stator 24, the connection portion 442 of the temperature detection unit 43 is surrounded by the cover member 46. This prevents contact between the connection portion 442 and the bus bar connection portion 412, can prevent and malfunction of the temperature detection unit 43. It is possible to prevent a short circuit between the connection portion 442 and the bus bar connection portion 412 due to adhesion of water, dust, foreign matters, or the like. This can prevent a large current from being applied to the temperature detection element 45.

A cover member 5 of a temperature detection unit 43aaccording to the first modification will be described with reference to the drawings. FIG. 9 is a cross-sectional view of the cover member 5 according to the first modification. As illustrated in FIG. 9, in the temperature detection unit 43a, the cover member 5 is different from the cover member 46 of the temperature detection unit 43 illustrated in FIG. 8. A part of the temperature detection unit 43a other than the cover member 5 has the same configuration as the temperature detection unit 43. Therefore, substantially the same parts as those of the temperature detection unit 43 of the temperature detection unit 43a are denoted by the same reference signs, and the detailed description of the same parts is omitted.

As illustrated in FIG. 9, the cover member 5 includes a first member 51 and a second member 52. The first member 51 protrudes upward from the upper surface of the holding portion 42 of the bus bar unit 4. The second member 52 protrudes downward from the lower surface of the inverter unit 3. A recess portion 511 recessed downward is formed at the upper end portion of the first member 51. A protrusion portion 521 protruding downward is formed at the lower end portion of the second member 52. Then, the first member 51 supports the connection portion 442. The second member 512 supports the inverter connection portion 32.

When the inverter unit 3 is attached from above the motor portion 2, the protrusion portion 521 of the second member 52 is accommodated in the recess portion 511 of the first member 51. This accurately positions the first member 51 and the second member 52. As a result, the lower end portion of the inverter connection portion 32 is inserted into the connection recess portion 443 of the connection portion 442, and the inverter connection portion 32 and the connection portion 442 are reliably electrically connected.

Since such configuration supports the inverter connection portion 32 and the connection portion 442, electrical connection can be made more reliably.

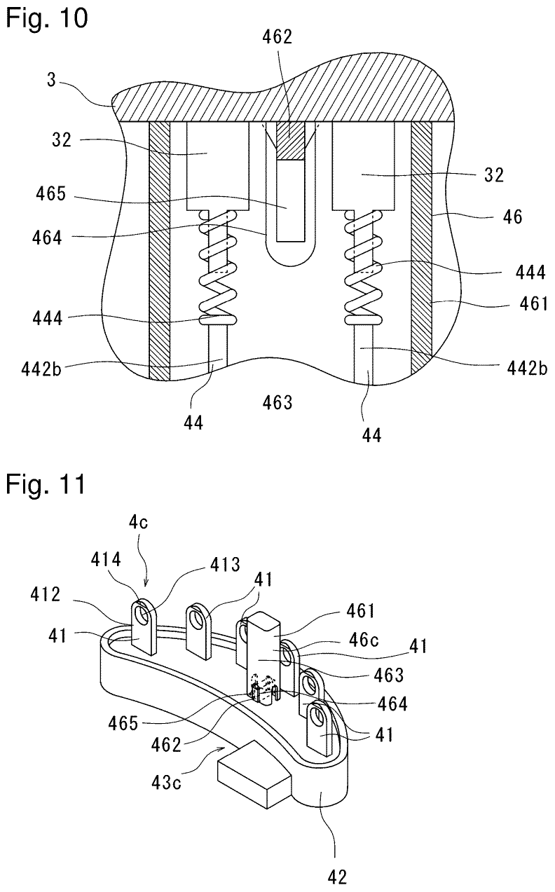

FIG. 10 is a schematic view illustrating a connection portion 442b of the second modification. As illustrated in FIG. 10, an upper end portion of the connection portion 442b is formed of a coil spring 444. Note that the upper end portion of the connection portion 442 is not limited to the coil spring 444, and may have any elastically deformable configuration. An elastically deformable part is not limited to the upper end portion. That is, at least the connection portion 442b of the energization unit 44 is elastically deformable.

With such configuration, when the axial positions of the inverter unit 3 and the bus bar unit 4 are deviated, the coil spring 444 at the tip end of the connection portion 442b expands and contracts. This can suppress the contact pressure with the inverter connection portion 32 and the connection portion 442b from becoming too strong or the contact from becoming insufficient.

A temperature detection unit 43c according to the third modification will be described with reference to the drawings. FIG. 11 is a perspective view of a bus bar unit 4c according to the third modification. In the temperature detection unit 43c of the bus bar unit 4c illustrated in FIG. 11, a cover member 46c is different from the cover member 46 of the temperature detection unit 43 of the bus bar unit 4 illustrated in FIG. 4 and the like. A part of the temperature detection unit 43c other than the cover member 46 has the same configuration as the temperature detection unit 43. Therefore, substantially the same parts as those of the temperature detection unit 43 of the temperature detection unit 43c are denoted by the same reference signs, and the detailed description of the same parts is omitted.

As illustrated in FIG. 11, a first member 461c of the cover member 46c is disposed in the inverter unit 3, and a second member 462c is disposed in the holding portion 42 of the bus bar unit 4. That is, the first member 461c is disposed on one of the inverter unit 3 and the holding portion 42, and the second member 462c is disposed on the other of the inverter unit 3 and the holding portion 42. Also in a case of such configuration, the inverter connection portion 32 and the connection portion 442 can be accurately electrically connected.

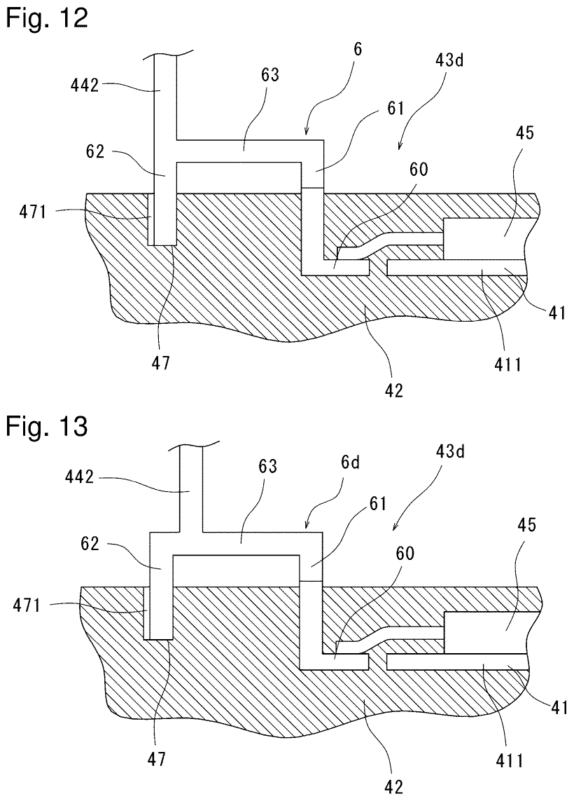

An energization unit 6 of a temperature detection unit 43d according to the fourth modification will be described with reference to the drawings. FIG. 12 is a schematic diagram of the energization unit 6 according to the fourth modification. In the temperature detection unit 43d illustrated in FIG. 12, the energization unit 6 is different from the energization unit 44 of the temperature detection unit 43 illustrated in FIG. 5 and the like. A part of the temperature detection unit 43d other than the energization unit 6 has the same configuration as the temperature detection unit 43. Therefore, substantially the same parts as those of the temperature detection unit 43 of the temperature detection unit 43d are denoted by the same reference signs, and the detailed description of the same parts is omitted.

Similarly to the energization unit 44, the energization unit 6 electrically connects the temperature detection element 45 and the inverter unit 3. The energization unit 6 is formed by bending a conductive metal plate made of aluminum, copper, or the like. As illustrated in FIG. 12, the energization unit 6 includes a conductive portion 60, a first leg portion 61, a second leg portion 62, and a coupling portion 63.

The conductive portion 60 is disposed on the holding portion 42. The temperature detection element 45 is electrically connected to the conductive portion 60. The conductive portion 60 and the terminal of the temperature detection element 45 are fixed by, for example, soldering, but are not limited to this, and may be fixed by a fixing method such as screwing. The conductive portion 60 expands in a direction intersecting the axial direction.

The first leg portion 61 extends axially upward from the conductive portion 60. The first leg portion 61 is formed integrally with the conductive portion 60, but is not limited to this, and may be formed separately and fixed by a fixing method such as screwing, soldering, or welding. That is, the first leg portion 61 is electrically connected to the conductive portion 60.

The second leg portion 62 is disposed in parallel with first leg portion 61. The second leg portion 62 comes into contact with holding portion 42. Due to this, the energization unit 6 is stably disposed. The upper end of the first leg portion 61 and the upper end of the second leg portion 62 are coupled by the coupling portion 63. That is, the coupling portion 63 couples the end portions of the first leg portion 61 and the second leg portion 62.

The connection portion 442 protrudes upward from the coupling portion 63. That is, the connection portion 442 extends from the coupling portion 63 in a direction opposite to the first leg portion 61 and the second leg portion 62. The connection portion 442 is electrically connected to the inverter connection portion 32 protruding downward from the lower surface of the inverter unit 3. Thus, the connection portion 442 is connected to the inverter connection portion 32, whereby the temperature detection element 45 is electrically connected to the inverter unit 3.

With such shape of the energization unit 6, even when the temperature detection element 45 is disposed at a position away from the inverter connection portion 32 when viewed in the axial direction, the temperature detection element 45 and the inverter unit 3 can be stably electrically connected. It is possible to increase the degree of freedom of arrangement of the temperature detection element 45. This enables the temperature detection element 45 to be disposed at a position where the temperature of the coils 26 can be more accurately detected.

The lower end portion of the second leg portion 62 is disposed in a hole portion 47 formed in the holding portion 42. That is, the tip end portion of the second leg portion 62 is disposed in the hole portion 47 formed in the holding portion. Such configuration enables the connection portion 442 to be positioned with respect to the holding portion 42. Since the movement in the direction intersecting the central axis Cx is limited, the connection portion 442 can be accurately electrically connected to the inverter unit 3. Note that the lower end portion of the second leg portion 62 may be in contact with the bottom surface of the hole portion 47 or may be disposed above the bottom surface.

Furthermore, as illustrated in FIG. 12, a gap 471 may be formed between at least one surface of the outer peripheral surface of the second leg portion 62 and the inner peripheral surface of the hole portion 47. By providing the gap 471 between the inner peripheral surface of the hole portion 47 and the outer peripheral surface of the second leg portion 62, transmission of a force due to vibration and impact of the motor portion 2 to the energization unit 6 is suppressed.

FIG. 13 is a schematic diagram of another example of an energization unit 6d of the fourth modification. As in the energization unit 6d illustrated in FIG. 13, the connection portion 442 may be deviated from the second leg portion 62 as viewed from the axial direction. At this time, the connection portion 442 is disposed closer to the second leg portion 62 than the first leg portion 61. That is, the connection portion 442 is disposed closer to the second leg portion 62 than the first leg portion 61 as viewed in the axial direction. Even in the energization unit 6d having such configuration, since the second leg portion 62 is near the connection portion 442 when viewed vertically, the connection portion 442 can be disposed at an accurate position with respect to the inverter unit 3. Even in a case where the position of the hole portion 47 is axially deviated from the connection portion 442, the inverter unit 3 and the temperature detection element 45 can be stably electrically connected.

Although the embodiments of the present invention have been described above, the respective configurations in the embodiments and combinations thereof are merely examples, and addition, omission, substitution, and other changes can be appropriately made within a range not departing from the gist of the present invention. The present invention is not limited by the embodiments.

The motor unit of the present invention can be used as a power source in which an inverter and a motor are connected.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor unit comprising:
a shaft rotatable about a central axis extending vertically;
a rotor rotatable about the central axis together with the shaft;
a stator radially facing the rotor;
an inverter unit electrically connected to the stator; and
a bus bar unit electrically connecting the stator and the inverter unit, wherein
the bus bar unit includes
at least one bus bar,
a temperature detection unit that detects a temperature of the bus bar, and
a holding portion that holds the bus bar and the temperature detection unit,
the bus bar includes a bus bar connection portion protruding from the holding portion,
the temperature detection unit includes
a temperature detection element fixed to the holding portion, and
an energization unit electrically connected to the temperature detection element,
the energization unit includes a connection portion protruding from the holding portion and electrically connected to the inverter unit, and
the connection portion radially overlaps the bus bar connection portion.

2. The motor unit according to claim 1, wherein
the inverter unit is disposed on an axial one side with respect to the stator,
the bus bar connection portion protrudes from the holding portion to the axial one side,
the connection portion protrudes from the holding portion to an axial one side, and
the connection portion is disposed radially inward relative to the bus bar connection portion.

3. The motor unit according to claim 1, wherein
the temperature detection unit includes a cover member covering an outer periphery of the connection portion, and
at least one of the inverter unit and the holding portion includes at least a part of the cover member.

4. The motor unit according to claim 3, wherein
the cover member includes
a first member including a recess portion, and
a second member including a protrusion portion accommodated inside the recess portion, and
the first member is disposed on one of the inverter unit and the holding portion, and the second member is disposed on another of the inverter unit and the holding portion.

5. The motor unit according to claim 1, wherein at least the connection portion of the energization unit is elastically deformable.

6. The motor unit according to claim 1, wherein
the energization unit includes
a conductive portion electrically connected to the temperature detection element,
a first leg portion electrically connected to the conductive portion,
a second leg portion disposed in parallel with the first leg portion, and
a coupling portion coupling end portions of the first leg portion and the second leg portion, and
the connection portion extends in a direction opposite to the first leg portion and the second leg portion from the coupling portion.

7. The motor unit according to claim 6, wherein a tip end portion of the second leg portion is disposed in a hole portion formed in the holding portion.

8. The motor unit according to claim 7, wherein a gap is formed between at least one surface of an outer peripheral surface of the second leg portion and an inner peripheral surface of the hole portion.

9. The motor unit according to claim 6, wherein the connection portion is disposed closer to the second leg portion than the first leg portion as viewed in an axial direction.
